(19) United States
(12) Patent Application Publication
(10) Pub. No.: US 2018/0130444 A1
(43) Pub. Date: May 10, 2018

(54) INFORMATION IMAGE DISPLAY APPARATUS AND METHOD

(71) Applicant: ELECTRONICS AND TELECOMMUNICATIONS RESEARCH INSTITUTE, Daejeon (KR)

(72) Inventors: Seung Il MYONG, Daejeon (KR); Dong Beom SHIN, Daejeon (KR); Kang Bok LEE, Daejeon (KR); Myung Nam BAE, Daejeon (KR)

(21) Appl. No.: 15/805,247

(22) Filed: Nov. 7, 2017

(30) Foreign Application Priority Data
Nov. 7, 2016 (KR) 10-2016-0147664
Sep. 29, 2017 (KR) 10-2017-0128264

(51) Int. Cl. G09G 5/02

(52) U.S. Cl. CPC G09G 5/026; G09G 2320/02; G09G 2340/06; G09G 2320/0666

(57) ABSTRACT

An information image display apparatus includes an illuminance sensor sensing illuminance of incident light; a processor for determining a transmittance of a polarizer according to the illuminance sensed by the illuminance sensor, outputting a control signal according to the sensed illuminance, analyzing an entire or partial area of a foreground image of external environment to determine a dominant color of the entire or partial area, and displaying an information image using a color contrasted with dominant color; and a polarizer for selectively transmitting the incident light by adjusting a degree of polarization according to the control signal input from the processor.

### CROSS-REFERENCE TO RELATED APPLICATIONS

This application claims priority to Korean Patent Applications No. 10-2016-0147664, filed on Nov. 7, 2016, and No. 10-2017-0128264, filed on Sep. 29, 2017 in the Korean Intellectual Property Office (KIPO), the entire contents of which are hereby incorporated by reference.

### BACKGROUND

### 1. Field of the Invention

The present disclosure relates to an apparatus and a method for displaying information images, and more specifically, to an apparatus and a method for displaying information images by enhancing visibility of the information images.

### 2. Description of Related Art

In general, an optical instrument or a lens equipped in front of the eyes for correcting visual acuity by being attached to the eyes or for protecting the eyes is referred to as eyeglasses or spectacles. As such, the eyeglasses or the lens is a term generally referred to as an apparatus that allows an image to be viewed through optical transmission. Also, the eyeglasses to which a projection insert is additionally provided for optical projection are referred to as a spectacle-type display apparatus including an optical imaging device. Such an optical imaging device provided in the form of the projection insert may include a prism, a wave plate, and the like.

Such the optical imaging device can be usefully used by a user such as firefighters who perform fire suppression, emergency rescue, and rescue missions in a fire scene, for example, when the user is in a situation where visibility is not ensured. In connection with this, an attempt has been made to increase the visibility of output imagers by damping illuminance of the external environment by placing an optical filter on a front side of the spectacle-type display apparatus in accordance with the purpose of use of the apparatus. In order to increase the visibility of output images, it is necessary to reduce the illuminance coming into the eyes through the optical filter. However, excessive reduction of the illuminance may cause the side effect that the firefighters coping with the crisis situation do not notice the surrounding foreground.

Also, considering the surrounding situation of the disaster scene where the color of the foreground changes and the illuminance changes from time to time, there is a limitation in sufficiently securing the visibility by manually manipulating the illuminance or adjusting only the illuminance of the external environment.

### SUMMARY

Accordingly, embodiments of the present disclosure provide an information image display apparatus for displaying information images in a color contrasted with a foreground color.

Accordingly, embodiments of the present disclosure also provide an information image display method for displaying information images in a color contrasted with a foreground color.

Accordingly, embodiments of the present disclosure also provide an information image display control apparatus.

In order to achieve the objective of the present disclosure, an information image display apparatus may comprise an illuminance sensor sensing illuminance of incident light; a processor for determining a transmittance of a polarizer according to the illuminance sensed by the illuminance sensor, outputting a control signal according to the sensed illuminance, analyzing an entire or partial area of a foreground image of external environment to determine a dominant color of the entire or partial area, and displaying an information image using a color contrasted with dominant color; and a polarizer for selectively transmitting the incident light by adjusting a degree of polarization according to the control signal input from the processor.

The processor may output the control signal for adjusting the degree of polarization to be lower as the sensed illuminance is higher.

The color contrasted with the dominant color may be set as a complementary color of the dominant color.

The partial area may be an area where the information image is displayed in the entire area of the foreground image.

The processor may determine the dominant color of the entire or partial area by analyzing a Red-Green-Blue (RGB) histogram of the foreground image.

The apparatus may further comprise an image output unit for outputting the information image using the color contrasted with the dominant color.

The apparatus may further comprise an optical imaging unit for projecting an image output from the image output unit to a virtual screen, which includes at least one of a lens, a minor, a prism, and a polarization splitter.

In order to achieve the objective of the present disclosure, an information image display method may comprise acquiring illuminance information of external environment by sensing illuminance of incident light; determining a transmittance of a polarizer according to the illuminance information; selectively transmitting the incident light by adjusting a degree of polarization according to the determined transmittance; analyzing an entire or partial area of a foreground image of the external environment to determine a dominant color of the entire or partial area; and outputting an information image by using a color contrasted with the dominant color.

In the determining a transmittance, the transmittance may be determined to be lower as the sensed illuminance is higher.

The color contrasted with the dominant color may be set as a complementary color of the dominant color.

The partial area may be an area where the information image is displayed in the entire area of the foreground image.

The dominant color of the entire or partial area may be determined by analyzing a Red-Green-Blue (RGB) histogram of the foreground image.

The method may further comprise projecting the information image to a virtual screen by using an optical imaging device which includes at least one of a lens, a mirror, a prism, and a polarization splitter.

In order to achieve the objective of the present disclosure, an information image display control apparatus may comprise at least one processor and a memory storing at least one instruction executed by the at least one processor. Also, the at least one processor may be configured to acquire illuminance information of external environment by sensing illuminance of incident light; determine a transmittance of a polarizer according to the illuminance information; selectively transmit the incident light by adjusting a degree of polarization according to the determined transmittance; determine a dominant color of an entire or partial area of a foreground image of the external environment by analyzing the entire or partial area; and output an information image by using a color contrasted with the dominant color.

The at least one instruction may be further configured to determine the transmittance to be lower as the sensed illuminance is higher.

The at least one instruction may be further configured to determine the dominant color of the entire or partial area by analyzing a Red-Green-Blue (RGB) histogram of the foreground image.

The color contrasted with the dominant color may be set as a complementary color of the dominant color.

The partial area may be an area where the information image is displayed in the entire area of the foreground image.

The at least one instruction may be further configured to project the information image to a virtual screen by using an optical imaging device which includes at least one of a lens, a minor, a prism, and a polarization splitter.

According to the embodiments of the present disclosure, it is made possible to automatically adjust the illuminance and change the brightness and the saturation of the information images or contents according to the external foreground color by automatically reacting to the external illuminance varying in real time, thereby actively coping with varying disaster environments.

Also, According to the embodiments of the present disclosure as described above, not only the visibility of the external environmental objects can be improved by adjusting the transmittance, but also the visibility of the information images can be improved by displaying the information images in a color contrasted with the foreground color.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating an operation of a conventional spectacle-type display apparatus;

FIGS. 2A to 2C illustrate information images in foregrounds having various transmittances according to polarization adjustment when the foreground color is green;

FIGS. 3A to 3C illustrate information images in foregrounds having various transmittances according to polarization adjustment when the foreground color is red;

FIG. 4 is a conceptual diagram illustrating an operation of a spectacle-type display apparatus according to an embodiment of the present disclosure;

FIG. 5 is a diagram illustrating a concept of a method of extracting foreground color information according to an embodiment of the present disclosure;

FIG. 6 is a conceptual diagram illustrating appearance of a smart helmet to which the information image display apparatus according to the present disclosure is applied;

FIG. 7 is a block diagram illustrating configuration of an information image display apparatus according to an embodiment of the present disclosure; and

FIG. 8 is a flowchart for explaining an information image display method according to an embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings.

According to embodiments of the present disclosure, when information images are provided through a spectacle-type display apparatus, visibility of information images may be enhanced by reducing illuminance of external environments (e.g., sunlight brightness) through a polarization controller. Also, an optical imaging device insert, at least one polariser element, and a light sensor may be used for automatically controlling the illuminance, and the information images may be displayed in a color contrasted with a foreground color coming into an image input device.

As described above, it is necessary to have a function of actively coping with various environmental changes of disaster situations by changing brightness and saturation of the information images or contents according to an external foreground color and using an illuminance control device that automatically reacts to external illuminance changing in real time.

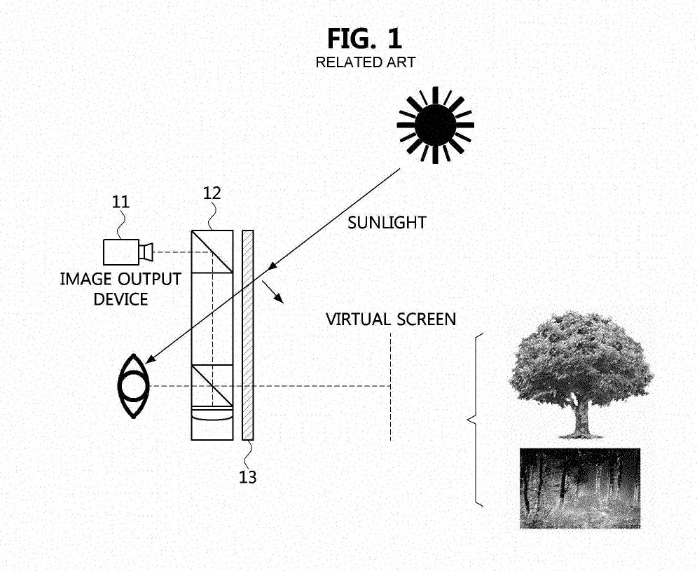

FIG. 1 is a conceptual diagram illustrating an operation of a conventional spectacle-type display apparatus.

Referring to FIG. 1, a conventional spectacle-type display apparatus may comprise an image output device 11, an optical lens 12 including, a projection insert, and a polarizer 13.

The projection insert included in the optical lens 12 is constituted by an optical imaging device. The optical, imaging device may form shapes of light rays coming from an electro-optical system which generates lights from electronic signals of the image output device 11, and provide a polarization direction to direct the light rays towards eyes of a wearer of the spectacle-type display apparatus. The optical imaging device allows the wearer of the spectacle-type display apparatus to visually identify information, contents represented by the electronic signals on a virtual screen by directing the light rays toward the eyes of the wearer of the spectacle-type display apparatus.

The optical imaging device may be configured to include at least one prism, at least one quarter-wave plate, at least one mirror, or the like, and may be arranged to be inserted into a mirror as shown in FIG. 1.

The image output device 11 may receive electronic signals from an associated processor located inside or outside the spectacle-type display apparatus, and generate, for example, a pixelated image corresponding to the electronic signals. The image output device 11 may be, for example, a small screen, a laser diode, or a light emitting diode, and any type of output device may be used as long as it is capable of processing and outputting digitally informed image data.

The spectacle-type display apparatus of FIG. 1 may also include the polarizer 13 facing one side of the optical lens 12. The polarizer may mean an optical instrument that selectively transmits a linearly polarized light in a specific direction among randomly polarized lights. The polarizer 13 may selectively absorb or refract the linearly polarized light in one direction and pass only linearly polarized light perpendicular to the direction. Here, the polarizer 13 may be an active optical filter capable of adjusting the polarization.

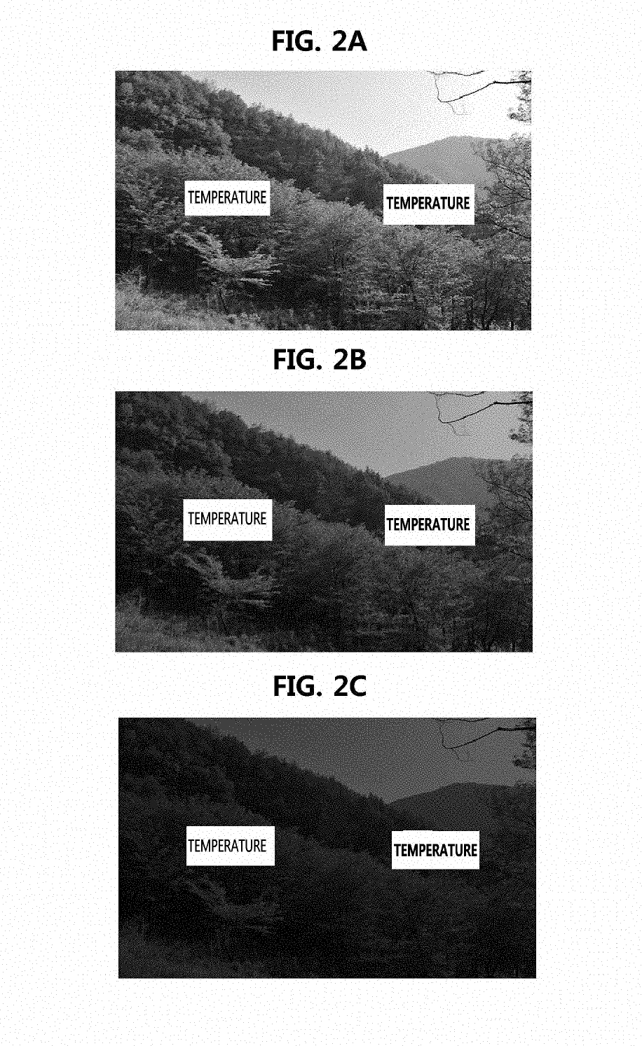

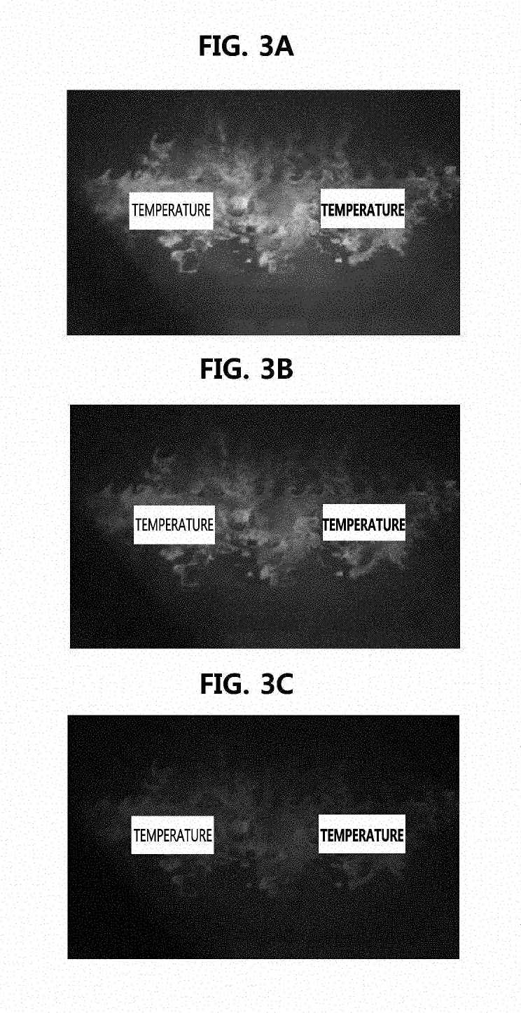

The polarization of the active optical filter can be adjusted to control the incidence of sunlight, and FIGS. 2A to 2C and FIGS. 3A to 3C illustrate examples of images having various transmittances according to the degree of polarization adjustment as described above.

FIGS. 2A to 2C illustrate information images in foregrounds having various transmittances according to polarization adjustment when the foreground color is green.

That is, FIGS. 2A to 2C illustrate information images in the foregrounds having transmittances of 100%, 70%, and 40%, respectively, with respect to sunlight incident by adjusting the polarization of the active optical filter when the foreground color is green. In the drawings, the information images are a text image having ‘temperature’ represented in green and a text image having ‘temperature’ represented in red.

That is, FIG. 2A illustrates an information image in a foreground having 100% transmittance, FIG. 2B illustrates an information image in a foreground having a 70% transmittance, and FIG. 2C illustrates an information image in a foreground having a transmittance of 40%.

As shown in FIGS. 2A to 2C, when the foreground of the external environment is green, it is confirmed that the visibility of the information image is significantly lowered when the color of the information image is green. Also, it is confirmed that the green information is most visible in the foreground having the transmittance of 40% with the lowest transparency among the three images, but it may be difficult to distinguish objects in shadow areas of the foreground.

FIGS. 3A to 3C illustrate information images in foregrounds having various transmittances according to polarization adjustment when the foreground color is red.

That is, FIGS. 3A to 3C illustrate information images in the foregrounds having transmittances of 100%, 70%, and 40%, respectively, with respect to sunlight incident by adjusting the polarization of the active optical filter when the foreground color is red. In the drawings, the information images are a text image having ‘temperature’ represented in green and a text image having ‘temperature’ represented in red.

In the cases of FIGS. 3A to 3C in which the foregrounds of the external environments are in a red color, results opposite to those of FIGS. 2A to 2C may be shown. That is, when the color of the information images is red in FIGS. 3A to 3C, the visibility of the information is considerably deteriorated.

Also, in the case of FIG. 3C showing the foreground image with 40% transmittance as the case of FIG. 2C, the red information is most visible among the three images, but it may be also difficult to distinguish objects in shadow areas of the foreground.

Through the examples of FIGS. 2A to 2C and FIGS. 3A to 3C, visibility of the information image is improved when the transmittance is lowered, but visibility of the external environmental object is lowered. On the contrary, visibility of the information image is lowered when the transmittance is increased, but visibility of the external environment is improved.

However, the visibility of external environmental objects (or people) is very important in case that firefighters perform their duties of fire-fighting and rescue missions. Therefore, it is necessary to increase the transmittance for the visibility of the external environmental object. In this case, there is a problem that the visibility of the important information displayed on the spectacle-type display apparatus is lowered when the color of the information image is similar to the foreground color, so that the important information may be missed.

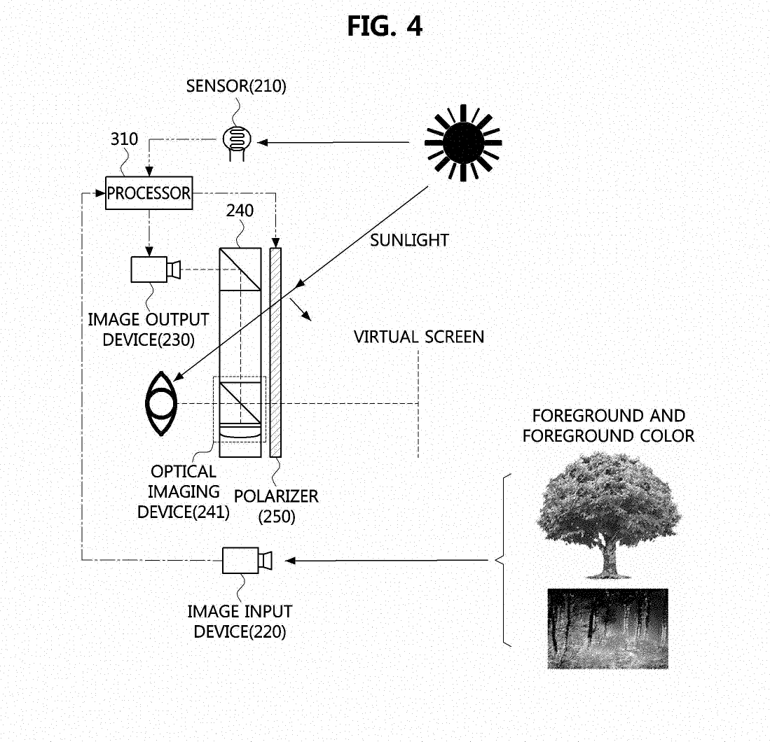

FIG. 4 is a conceptual diagram illustrating an operation of a spectacle-type display apparatus according to an embodiment of the present disclosure.

The spectacle-type display apparatus according to an embodiment of the present disclosure may comprise an optical lens 240 including a projection insert, a polarizer 250, an image output device 230, a sensor 210, an image input device 220, and a processor 310. The spectacle-type display apparatus of FIG. 4 may also be referred to as an information image display apparatus.

The optical lens 240 may include an optical imaging device 241 as the projection insert. The optical imaging device 241 may comprise at least one prism, at least one quarter-wave plate, at least one mirror, and the like, and may be inserted into the optical lens 240.

As indicated by a dotted line in FIG. 4, light rays output from the image output device 230 may pass through the inside of the optical lens 240 via prism or mirrors in the longitudinal direction, may reach a polarization splitter inside the optical imaging device 241, and then may be projected to a virtual screen through the internal elements such as the one or more prisms, quarter wave plates, and the like.

A wave plate is an optical element that changes a polarization state of a light passing through the plate, which is also referred to as a retarder. When an electromagnetic wave passes through the wave plate, a sum of two components (i.e., normal ray and extraordinary ray) parallel to or perpendicular to an optical axis of the polarization direction may be obtained, and a vector sum of the two components may change according to birefringence and thickness of the wave plate so that the polarization direction of the light may be changed.

Here, a wave plate that changes the polarization direction of light by 90 degrees may be called a half-wave plate, a wave plate that changes the polarization direction of light by 180 degrees may be called a full-wave plate, and a wave plate that changes the polarization direction of light by 45 degrees may be called a quarter-wave plate.

The polarizer 250 may be an active polarizing filter capable of actively adjusting the polarization according to an electric control signal input from the processor 310, and may include two or more polarizing elements. The polarizer 250 may also be configured as a plate that can be detached from the optical lens 240 or configured in a form of a layer that is permanently or temporarily adhered or coated to the optical lens 240 as an active film that controls each pixel.

The image output device 230 may receive electronic signals from the processor 310 and generate, for example, a pixelated image corresponding to the signals. The image output device 230 may be, for example, a small screen, a laser diode, or a light emitting diode.

Meanwhile, according to a preferred embodiment of the present disclosure, when providing an information image through the spectacle-type display apparatus, the brightness of the light input from the external environment (sunlight brightness) may be reduced by a certain ratio to improve the visibility of the information image.

In order to support this, the sensor 210 may be an illuminance sensor or a light sensor for measuring the illuminance of the external environment. The sensor 210 may also be, for example, a semiconductor (e.g., cadmiumsulfide (CdS)) that is conductive when light is incident. The CdS is a photovoltaic resistor whose resistance varies with light intensity, and the light intensity may be measured using a characteristic that the resistance decreases as the light intensity increases. Information on the illuminance measured by the sensor 210 may be transmitted to the processor 310.

Meanwhile, the image input device 220 may acquire an image of an external foreground and transmit the acquired image to the processor 310. A typical example of the image input device 220 may be a camera, but any type of image input device may be used as long as it is an input device for digitalizing a captured image.

The processor 310 may receive the external illuminance information from the sensor 210 and receive an external foreground image from the image input device 220.

The processor 310 may determine transmittance according to the external illuminance information, and control the polarizer 250 to adjust the transmittance using an illuminance control signal. Specifically, the processor 310 may control the transmittance to be lower as the external illuminance increases, that is, as more light enters the sensor 210. For example, the processor 310 may control the polarizer 250 so that the transmittance becomes about 70% in a bright daylight, and becomes about 100% in a dark night.

The processor 310 may also analyze the foreground image received from the image input device 220 to determine which color is dominant in the foreground image. Once the dominant color is determined, the processor 310 may control the image output device 230 to display the information image in a color contrasted with the dominant color. The processor 310 may also change brightness and saturation of the information image so that the information image can be represented in contrast to the dominant color of;the foreground image.

Here, the color contrasted with the dominant color may be set as a complementary color of the dominant color. In case that a white light is produced by mixing arbitrary two kinds of color light at a predetermined ratio, or in case that an achromatic color is produced by mixing two colors of different colors at an predetermined ratio, two colors at positions corresponding to each other in a color wheel are complementary to each other. For example, red and green, yellow and blue, and green and purple arc complementary to each other. In addition to these colors, the colors placed in the opposite positions in the color wheel are complementary colors.

The processor 310 may determine the dominant color of the foreground image using a color histogram, for example, an RGB histogram, in analyzing the color of the foreground image.

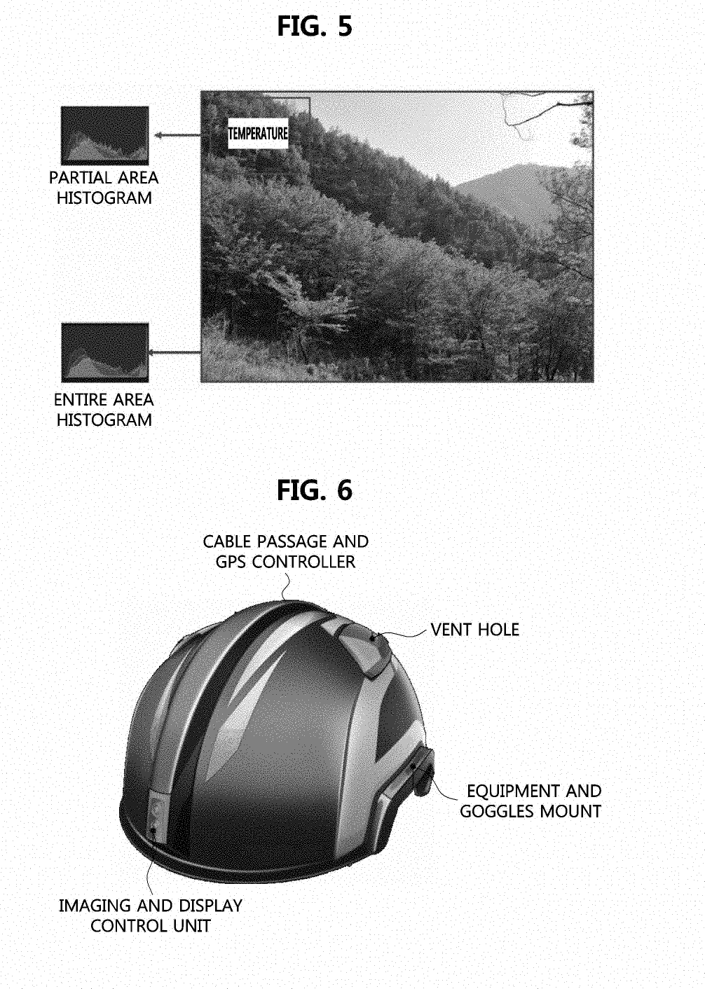

FIG. 5 is a diagram illustrating a concept of a method of extracting foreground color information according to an embodiment of the present disclosure.

FIG. 5 illustrates an RGB histogram for the entire area of the foreground image, and an RGB histogram for the partial, area in the foreground image, which are obtained through color analysis for the foreground image.

The RGB histogram for the entire area of the foreground image is shown at the lower left of the foreground image, and the RGB histogram for the partial area is shown at the upper left of the foreground image.

Here, color histograms are commonly used to represent color distribution of an image in image processing and photography. For a digital image, a color histogram may represent a list of fixed color ranges corresponding to a color space of the image, and the number of pixels representing the number of colors in all possible color sets.

Color histograms are often used in three-dimensional spaces such as Red-Green-Blue (RGB) or Hue-Saturation-Value (HSV), but they may be made to fit any kind of color spaces. For a multispectral image where each pixel is represented by an arbitrary number of measurement values (e.g., three measurement values corresponding to RGB), the color histogram may be N-dimensional, and N may represent the number of measurement values.

It is possible to extract the foreground color by processing the entire area, of the foreground image. In this case, however, since it takes a lot of time to process the entire image, an embodiment, in which only the partial area corresponding to a display area of the information image is subjected to image processing to extract the dominant color, is illustrated in FIG. 5.

That is, the selected partial area of the entire image may be set as an area in which the information image is displayed. In this ease, a higher effect can be expected with less calculation amount than that of analyzing the color histogram for the entire image and extracting the color information.

FIG. 6 is a conceptual diagram illustrating appearance of a smart helmet to which the information image display apparatus according to the present disclosure is applied.

The smart helmet according to an embodiment of the present disclosure shown in FIG. 6 may be a helmet worn by a firefighter, but it may be utilized not only in the field of fire-fighting but also in other industrial fields and situations.

The smart helmet of FIG. 6 may include, for example, a power supply, a communication module, and a vent cover at the rear of the helmet, a cable passage and a global positioning system (GPS) controller on the top of the helmet, a mount that can hold equipment and goggles (or glasses) on the side of the helmet, and a vent hole at a side upper portion of the helmet. Also, an imaging and display control unit may be disposed at the front of the helmet.

The arrangement positions of the components shown in FIG. 6 are only one embodiment, and may be arranged in different configurations depending on the characteristics of the components and the wearer's convenience.

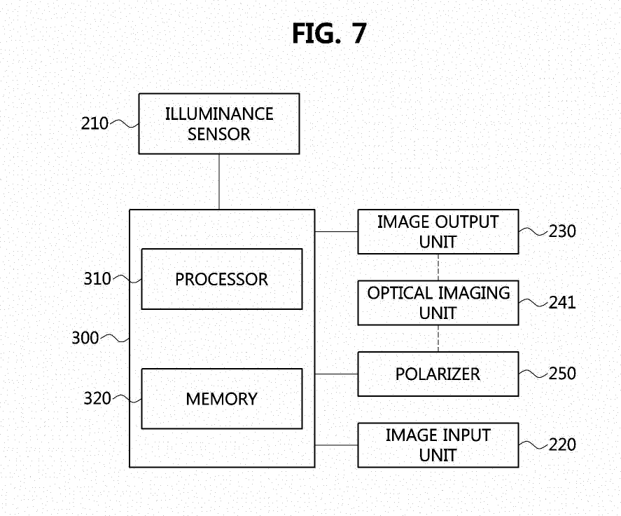

FIG. 7 is a block diagram illustrating configuration of an information image display apparatus according to an embodiment of the present disclosure.

The information image display apparatus according to an embodiment of the present disclosure may comprise an illuminance sensor 210, an image input unit 220, an optical imaging unit 241, a polarizer 250, an image output unit 230, and a display control device 300.

The illuminance sensor 210 may sense illuminance of incident light. The processor 310 may determine, a transmittance according to the illuminance information input from the illuminance sensor 210, output a control signal corresponding to the determined transmittance, analyze the entire area or partial area of a foreground image of an external environment to identify a dominant color of the analyzed area, and display an information image with a color contrasted with the dominant color.

Also, the polarizer 250 may adjust degree of polarization according to the control signal input from the processor 310. The image output unit 230 may output the information image using the color contrasted with the dominant color input from the processor 310. Also, the optical imaging unit 241 may include at least one of lens, mirror, prism, and polarization splitter, and project the image output from the image output device to a virtual screen.

Meanwhile, the display control device 300 may include at least one processor 310 and a memory 320 for storing instructions that direct the at least one processor to perform at least one step. Here, the at least one step performed by the at least one processor may include a step of determining the transmittance of the polarizer in accordance with the illuminance information of the external environment, a step of adjusting the degree of polarization according to the determined transmittance to selectively transmit the incident light, a step of analyzing the entire area or partial area of the foreground image of the external environment to identify the dominant color of the area, and a step of outputting the information image using the color contrasted with the dominant color.

The image input unit 220, the image output unit 230 and the optical imaging unit 241 in the embodiment of FIG. 7 may perform the same functions of those of the image input device 220, the image output device 230, and the optical imaging device 241 in the embodiment of FIG. 4. In the present embodiment, only the names of the components are represented in a sense that they are included in the information image display apparatus as internal components thereof.

Also, the information image display apparatus may be understood as the same concept as the spectacle-type display apparatus, but may be understood as a concept of sharing only some components. That is, the components shown in FIG. 7 may be distributed in the spectacle-type display apparatus and the smart helmet interworking with the spectacle-type display apparatus according to the characteristics of the components.

For example, the display control device 300 including the processor 310 and the memory 320, the illuminance sensor 210, the image input unit 220, and the like may be disposed in the helmet body, and the optical imaging unit 231 and the polarizer 250 and the like may be mounted on the glasses or goggles worn by the user.

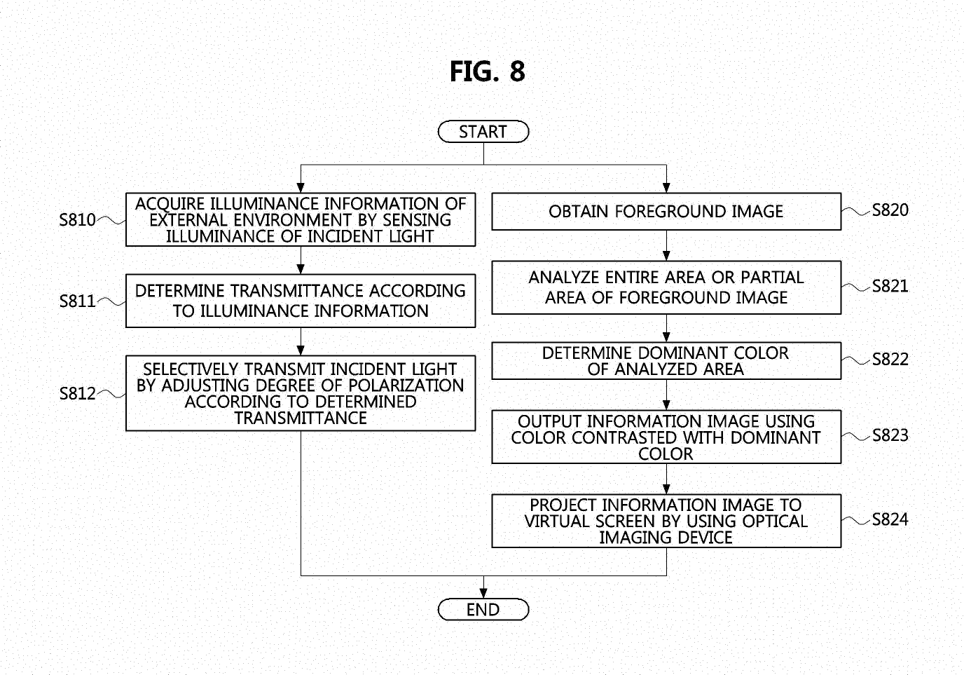

FIG. 8 is a flowchart for explaining an information image display method according to an embodiment of the present disclosure.

As shown in FIG. 8, the information image display method according to an embodiment of the present disclosure may proceed largely through two process flows, which are be performed by the information image display apparatus.

The first process flow may be a process flow (S810 to S812) for adjusting the degree of polarization of incident light, and the second process flow may be a process flow (S820 to S824) related to color adjustment of the information image.

According to the first process flow, the illuminance of the incident light may be sensed to acquire the illuminance information of the external environment (S810), the transmittance of the polarizer may be determined according to the illuminance information of the external environment (S811), and the incident light may be selectively transmitted by adjusting the degree of polarization according to the determined transmittance (S812). Here, transmittance may be adjusted to be lower for the higher external illuminance, and the transmittance may be adjusted to be higher for the lower external illuminance.

According to the second process flow, the foreground image may be obtained (S820), and the dominant color of the foreground image may be determined (S822) by analyzing the entire or partial area of the foreground image (S821). Once the dominant color is determined, the information image may be output using the color contrasted with the dominant color (S823). Here, the color contrasted with the dominant color may be set as the complementary color of the dominant color. Also, by changing brightness and saturation of the information image, the information image may be represented in a color contrasted with the dominant color of the foreground image.

The output information image may be projected to a virtual screen using an optical imaging device including at least one of lens, mirror, prism, and polarization splitter (S824). Here, the partial area may be an area of the entire foreground image where the information image is displayed. Also, the dominant color of the area may be derived through RGB histogram analysis of the foreground image.

According to the embodiments of the present disclosure as described above, not only the visibility of the external environmental objects can be improved by adjusting the transmittance, but also the visibility of the information images can be improved by displaying the information images in a color contrasted with the foreground color.

Therefore, according to the embodiments of the present disclosure, it is made possible to automatically adjust the illuminance and change the brightness and the saturation of the information images or contents according to the external foreground color by automatically reacting to the external illuminance varying in real time, thereby actively coping with varying disaster environments.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

While the embodiments of the present disclosure and their advantages have been described in detail, it should be understood that various changes, substitutions and alterations may be made herein without departing from the scope of the present disclosure.

What is claimed is:

1. An information image display apparatus comprising:
an illuminance sensor sensing illuminance of incident light;
a processor for determining a transmittance of a polarizer according to the illuminance sensed by the illuminance sensor, outputting a control signal according to the sensed illuminance, analyzing an entire or partial area of a foreground image of external environment to determine a dominant color of the entire or partial area, and displaying an information image using a color contrasted with dominant color; and
a polarizer for selectively transmitting the incident light by adjusting a degree of polarization according to the control signal input from the processor.

2. The information image display apparatus according to claim 1, wherein the processor outputs the control signal for adjusting the degree of polarization to be lower as the sensed illuminance is higher.

3. The information image display apparatus according to claim 1, wherein the color contrasted with the dominant color is set as a complementary color of the dominant color.

4. The information image display apparatus according to claim 1, wherein the partial area is an area where the information image is displayed in the entire area of the foreground image.

5. The information image display apparatus according to claim 1, wherein the processor determines the dominant color of the entire or partial area by analyzing a Red-Green-Blue (RGB) histogram of the foreground image.

6. The information image display apparatus according to claim 1, further comprising an image output unit for outputting the information image using the color contrasted with the dominant color.

7. The information image display apparatus according to claim 6, further comprising an optical imaging unit for projecting an image output from the image output unit to a virtual screen, which includes at least one of a lens, a minor, a prism, and a polarization splitter.

8. An information image display method comprising:
acquiring illuminance information of external environment by sensing illuminance of incident light;
determining a transmittance of a polarizer according to the illuminance information;
selectively transmitting the incident light by adjusting a degree of polarization according to the determined transmittance;
analyzing an entire or partial area of a foreground image of the external environment to determine a dominant color of the entire or partial area; and
outputting an information image by using a color contrasted with the dominant color.

9. The information image display method according to claim 8, wherein, in the determining a transmittance, the transmittance is determined to be lower as the sensed illuminance is higher.

10. The information image display method according to claim 8, wherein the color contrasted with the dominant color is set as a complementary color of the dominant color.

11. The information image display method according to claim 8, wherein the partial area is an area where the information image is displayed in the entire area of the foreground image.

12. The information image display method according to claim 8, wherein the dominant color of the entire or partial area is determined by analyzing a Red-Green-Blue (RGB) histogram of the foreground image.

13. The information image display method according to claim 8, further comprising projecting the information image to a virtual screen by using an optical imaging device which includes at least one of a lens, a mirror, a prism, and a polarization splitter.

14. An information image display control apparatus comprising at least one processor and a memory storing at least one instruction executed by the at least one processor, wherein the at least one instruction is configured to:
acquire illuminance information of external environment by sensing illuminance of incident light;
determine a transmittance of a polarizer according to the illuminance information;
selectively transmit the incident light by adjusting a degree of polarization according to the determined transmittance;
determine a dominant color of an entire or partial area of a foreground image of the external environment by analyzing the entire or partial area; and
output an information image by using a color contrasted with the dominant color.

15. The information image display control apparatus according to claim 14, wherein the at least one instruction is further configured to determine the transmittance to be lower as the sensed illuminance is higher.

16. The information image display control apparatus according to claim 14, wherein the at least one instruction is further configured to determine the dominant color of the entire or partial area by analyzing a Red-Green-Blue (RGB) histogram of the foreground image.

17. The information image display control apparatus according to claim 14, wherein the color contrasted with the dominant color is set as a complementary color of the dominant color.

18. The information image display control apparatus according to claim 14, wherein the partial area is an area where the information image is displayed in the entire area of the foreground image.

19. The information image display control apparatus according to claim 14, wherein the at least one instruction is further configured to project the information image to a virtual screen by using an optical imaging device which includes at least one of a lens, a minor, a prism, and a polarization splitter.
